(19) United States
(12) Patent Application Publication
(10) Pub. No.: US 2013/0054818 A1
(43) Pub. Date: Feb. 28, 2013

(54) PROCESSING TERMINAL AND PROCESSING METHOD

(71) Applicants: Yasuhiro FURUTA, Shimosuwa-machi (JP); Yasuhiro OSHIMA, Matsumoto (JP); Hirotaka AKAMATSU, Matsumoto (JP); Hiroyuki SUZUKI, Shiojiri (JP)

(72) Inventors: Yasuhiro FURUTA, Shimosuwa-machi (JP); Yasuhiro OSHIMA, Matsumoto (JP); Hirotaka AKAMATSU, Matsumoto (JP); Hiroyuki SUZUKI, Shiojiri (JP)

(73) Assignee: SEIKO EPSON CORPORATION, Tokyo (JP)

(21) Appl. No.: 13/596,630

(22) Filed: Aug. 28, 2012

(30) Foreign Application Priority Data
Aug. 31, 2011 (JP) 2011-188939

(51) Int. Cl. G06F 15/16

(52) U.S. Cl. 709/227

(57) ABSTRACT

A processing terminal has a communication unit that establishes a connection with a server and conducts communication; a processing unit that executes predetermined processing based on information acquired from the server through the communication; a disconnection detecting unit that detects a disconnection of the connection; and a reconnecting unit that repeatedly attempts a reconnection with the server at first timing that is random and meets conditions that an expected value of the interval of the attempts is a predetermined certain value in a case where a disconnection of the connection is detected.

### CROSS-REFERENCE TO RELATED APPLICATIONS

This application claims priority to Japanese Patent Application No. 2011-188939 filed on Aug. 31, 2011. The entire disclosure of Japanese Patent Application No. 2011-188939 is hereby incorporated herein by reference.

### BACKGROUND

1. Technical Field

The present invention relates to a processing terminal and a processing method, and particularly relates to a technology for immediately executing a request from a user via a server in a cloud computing system.

2. Background Technology

A cloud computing system has been known, which provides service for causing a specified printer to conduct printing by e-mail transmission (for example, Patent Document 1). This cloud computing system has a server, and when the server receives specified e-mail, the server generates print data corresponding to a specified printer based on the e-mail. The specified printer registered in the server acquires print data from the server and executes printing. Accordingly, a user can use a printer that is registered in the server even if a printer driver is not installed in a client terminal such as a PC (personal computer) or a smartphone. In this system, when a printer associated with a specified e-mail address is registered in a server, any user who knows the e-mail address can use the printer.

Japanese Laid-open Patent Application No. 2008-71257 (Patent Document 1), is an example of the related art.

### SUMMARY

### Problems to Be Solved by the Invention

However, when the printer acquires print data from the server and executes printing by POP, the printer needs to conduct polling with respect to print data that exists in the server, which makes it difficult to achieve both of immediacy and reduction in network traffic or server load. Thus, in the above-described system, it is preferable to maintain an always-on connection using a push-type protocol, so that the printer can immediately receive print data from a user. As a push-type protocol, XMPP or SIP is known. However, even if an always-on connection is established by such a push-type protocol, there are cases where the connection is disconnected by a router, a firewall or a proxy server, or the connection is disconnected due to a problem in the server. In general, when a connection is disconnected, a reconnection is automatically attempted. However, it is likely that the server load becomes excessive due to a concentration of reconnection attempts. If the server is down due to a concentration of reconnection attempts, then subsequent reconnection attempts also concentrate, and a reconnection continues to fail. This is not limited to a case of an always-on connection or printing.

The invention has been made to address the above-described circumstances, and the advantage of the invention is to promptly establish a reconnection in a plurality of processing terminals to be connected with a server while dispersing the server load.

### Means Used to Solve the Above-Mentioned Problems

(1) In order to achieve the above-described advantage, a processing terminal has a communication unit that establishes a connection with a server and conducts communication; a processing unit that executes predetermined processing based on information acquired from the server through the communication; a disconnection detecting unit that detects a disconnection of the connection; and a reconnecting unit that repeatedly attempts a reconnection with the server at first timing that is random and meets conditions that an expected value of the interval of the attempts is a predetermined certain value in a case where a disconnection of the connection is detected.

According to the invention, when a connection with the server is disconnected, the disconnection is detected and a reconnection is repeatedly attempted at first timing. The first timing to attempt a reconnection is set randomly as long as the expected value of the interval (attempt interval) of the first timing is set in a predetermined certain value. Consequently, the average value of the interval of the first timing is a predetermined certain value although the first timing set in this manner is different per processing terminal. Specifically, in terms of each processing terminal, the number of times of reconnection attempts for a certain period of time is guaranteed. Also, in terms of a plurality of processing terminals, the timing to attempt a reconnection is made different. Consequently, when a state where a connection is disconnected transitions into a state where a reconnection is possible, it can be expected that a reconnection between a plurality of processing terminals and a server is established within the time of the expected value while dispersing the server load. Preferably, the random first timing is set by using a uniform random number. The expected value of the interval of reconnection attempts conducted with the random first timing does not need to be a certain value in a strict sense, and can have a margin of error or vary within a range acceptable in terms of the design.

(2) In the processing terminal to achieve the above-described advantage, the reconnecting unit can attempt a reconnection with the server at the first timing that occurs with random timing per a period of time having an equal length to the predetermined certain value.

In this case, in each processing terminal, one reconnection attempt is securely conducted at a certain interval. Specifically, attempt opportunities are further equalized in a plurality of processing terminals. A short period of time that is not uniform in the length can be inserted between periods in which one reconnection attempt is conducted as long as the expected value of the interval of reconnection attempts conducted at the random first timing is a certain value. For example, a blank period of one second and a blank period of two seconds can be inserted alternately.

(3) In the processing terminal to achieve the above-described advantage, the reconnecting unit can attempt a reconnection with the server at the first timing that occurs at an interval of random lengths that meets conditions that the expected value of the interval of the attempts is a predetermined certain value.

In this case, the interval itself of the first timing is random. Accordingly, although the number of times of reattempts does not coincide in each processing terminal per certain interval, since the expected value of the interval of the first timing is a predetermined certain value, attempt opportunities are equalized in a plurality of processing terminals by repeating a reconnection attempt in each processing terminal.

(4) In the processing terminal to achieve the above-described advantage, the reconnecting unit can attempt a reconnection with the server at predetermined second timing before the initial first timing occurs after a disconnection of the connection is detected.

In this case, if a disconnection state transitions into a state where a connection is possible in a short period of time, a connection can be established again before the initial first timing occurs. If the connection is disconnected due to a problem in the server and the server is restored before the second timing occurs, reconnection attempts concentrate in the server with respect to the second timing. However, a problem will not occur again due to load concentration in the server with respect to the second timing by defining the rule that the server will not be booted until a certain period of time elapses from the occurrence of the problem. Also, if the connection is disconnected due to a problem other than in the server, since the number of the processing terminals that conduct reconnection attempts is limited, reconnection attempts will not concentrate in the server.

(5) In the processing terminal to achieve the above-described advantage, the reconnecting unit can set the predetermined certain value based on connection control information acquired from the server.

The extent of load concentration in the server due to reconnection attempts depends on the number of processing terminals connected with the server. Accordingly, the interval of the first timing can be optimized by registering connection control information that determines the expected value of the interval of the first timing corresponding to the number of processing terminals to be connected with the server and setting the first timing based on the connection control information that the processing terminal acquires from the server. The connection control information can be any information as long as it can unambiguously set the expected value of the interval of reconnection attempts. For example, as the connection control information, the shipments of processing terminals, the number of the processing terminals registered in the server, or the number of the processing terminals actually connected to the server can be set.

The function of each unit described in the claims is achieved by hardware resources whose function is specified by the configuration itself, hardware resources whose function is specified by the program, or a combination thereof. Also, the function of each unit is not limited to one that is achieved by hardware resources physically independent of each other. For example, the server described in the claims is not limited to one that is achieved by one computer, and the server can be achieved as a group by combining a plurality of computers that take charge of each unit, respectively. Further, the invention can be implemented as a method, a computer program that causes a computer to achieve the above-described function, or a recording medium for the program. The recording medium for the computer program can be a magnetic recording medium, a magneto-optical recording medium, or any recording medium that will be developed in the future.

### BRIEF DESCRIPTION OF THE DRAWINGS

Referring now to the attached drawings which form a part of this original disclosure:

FIG. 1 is a block diagram showing an entire printing system that includes a printer as a processing terminal;

FIG. 2 is a flow chart showing a processing method;

FIG. 3 is a timing chart showing the processing method;

FIG. 4 is a flow chart showing a processing method; and

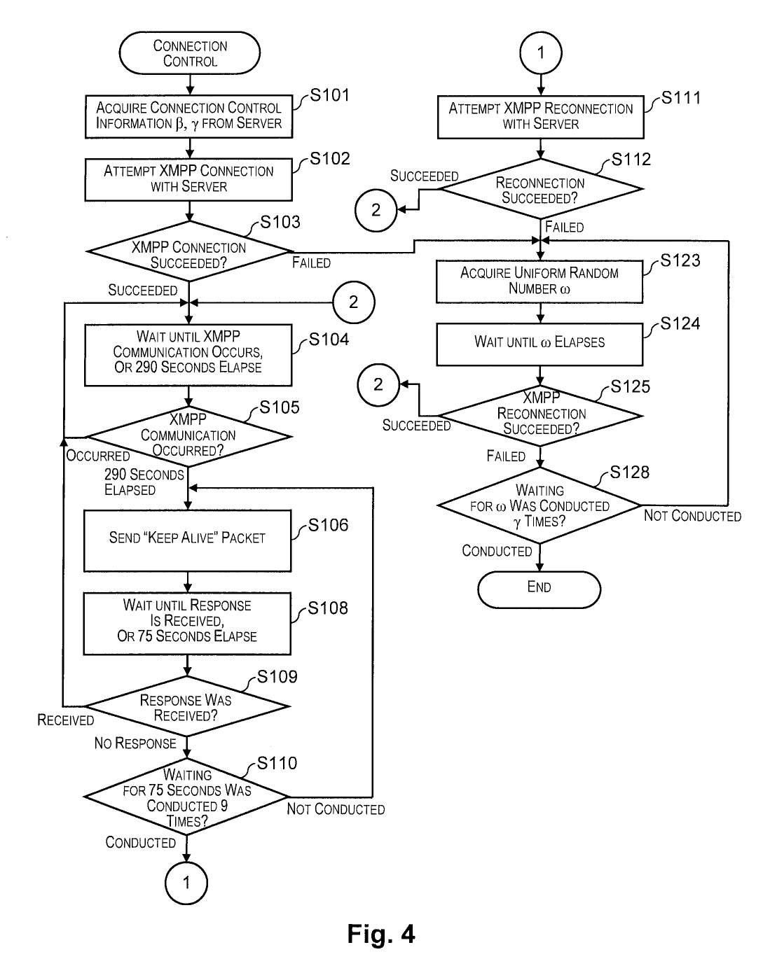

FIG. 5 is a timing chart showing the processing method.

### DETAILED DESCRIPTION OF EXEMPLARY EMBODIMENTS

Hereinafter, embodiments of the invention will be explained with reference to the attached drawings. Corresponding elements in the respective drawings have the same reference symbol, and overlapping explanations will be omitted.

### 1. Configuration

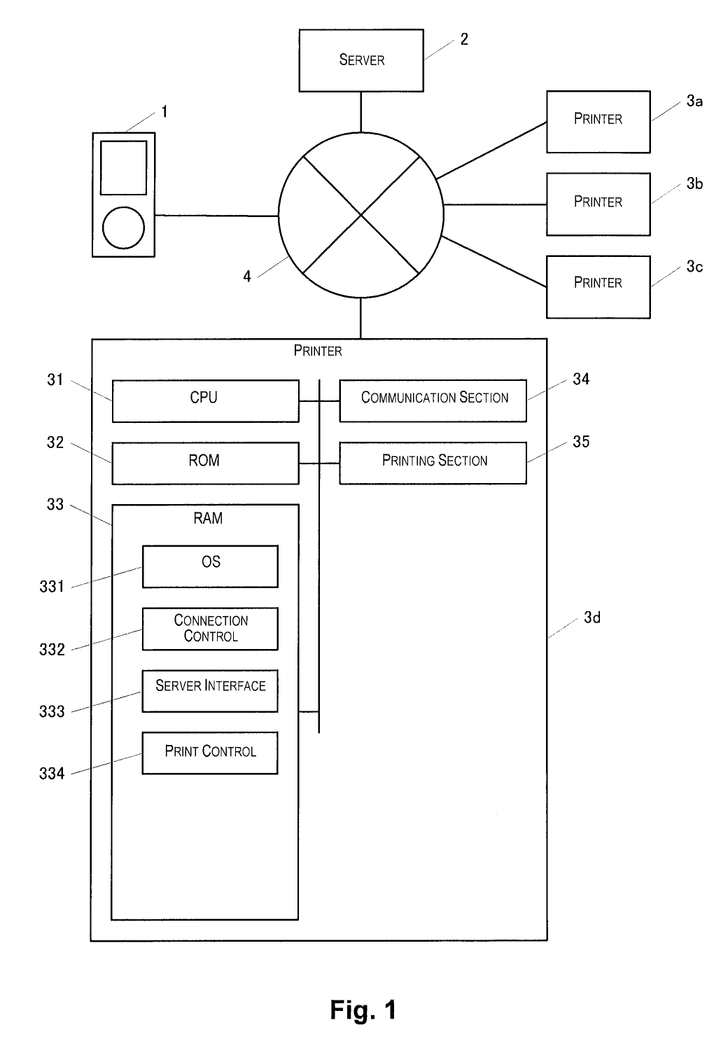

FIG. 1 shows a configuration of an entire printing system that includes printers 3a, 3b, 3c, and 3d as an embodiment of a processing terminal according to the invention. In the printing system shown in FIG. 1, when an e-mail is transmitted from an optional communication terminal 1 to an e-mail address associated with any one of the printers 3a, 3b, 3c, and 3d registered in a server 2, an attached file or a body text of the e-mail is printed by any one of the printers 3a, 3b, 3c, and 3d associated with the destination e-mail address. The server 2 is constructed of one or more computers. The server 2, the printers 3a, 3b, 3c, and 3d, and the communication terminal 1 are connected with the Internet 4. Since the configurations of the printers 3a, 3b, 3c, and 3d are substantially the same in terms of understanding the invention, the configurations of the printers 3a, 3b, 3c, and 3d are omitted in FIG. 1. Also, the printers 3a, 3b, 3c, and 3d are described as a printer 3 in the following explanations, and the printers 3a, 3b, 3c, and 3d are not distinguished unless necessary.

The printer 3 executes printing based on a request received from the server 2 through an always-on connection with the server 2. Accordingly, the printer 3 has a communication section 34 to transmit and receive messages via the Internet 4 in addition to standard elements of a printer such as a CPU 31, a ROM 32, a RAM 33, or a printing section 35. The communication section 34 converts signals received from the Internet 4 via a LAN in accordance with a protocol and sends to an internal bus, and also converts signals obtained from the internal bus in accordance with a protocol and sends to the Internet 4 via the LAN. The ROM 32 stores various kinds of computer programs to be read in the RAM 33 and be executed by the CPU 31. Various kinds of functions of the printer 3 are achieved by causing the CPU 31 to execute these computer programs.

An OS 331 controls hardware of the printer 3 in cooperation with various kinds of application programs such as a connection control module 332, a server interface module 333, or a print control module 334, and controls communication with the server 2 in accordance with a protocol such as TCP/IP, HTTP, or XMPP. The OS 331 is a computer program that causes the CPU 31 and the communication section 34 to serve as a communication unit. Account information necessary for the printer 3 to communicate with the server 2 in accordance with a protocol such as TCP/IP, HTTP, or XMPP is set in the printer 3 and the server 2 in advance.

The connection control module 332 establishes and maintains an always-on connection with the server 2 in accordance with XMPP. Also, the connection control module 332 detects a disconnection of the always-on connection with the server 2 in accordance with XMPP, and repeatedly attempts a reconnection of the always-on connection with the server 2 in accordance with XMPP at first timing that is random and is set based on connection control information acquired from the server 2 in advance when a disconnection is detected. The connection control module 332 is a computer program that causes the CPU 31 to serve as a connection detecting unit and a disconnection detecting unit.

The server interface module 333 acquires a print request or print data from the server 2 by communicating with the server 2 in accordance with a protocol such as HTTP or XMPP.

The print control module 334 acquires a print request or print data through the server interface module 333. When the print control module 334 acquires a print request or print data, the print control module 334 controls the printing section 35 and executes printing based on the print data. The print control module 334 is a computer program that causes the CPU 31 and the printing section 35 to serve as a processing unit.

### 2. First Embodiment of Processing Method

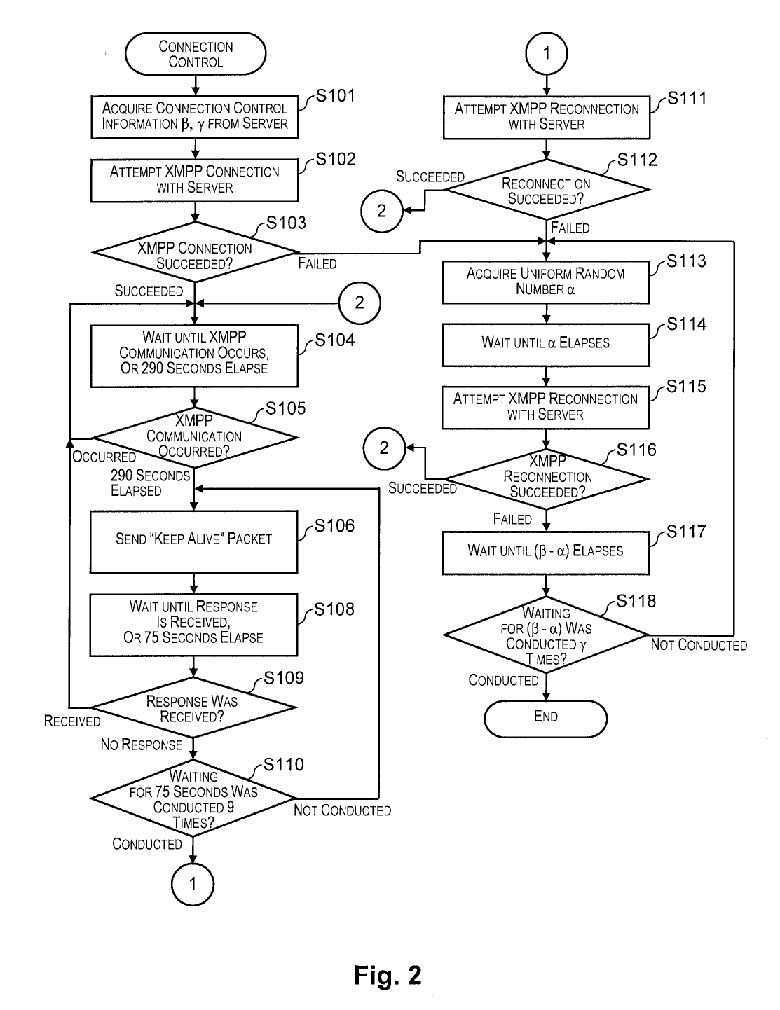

Next, a first embodiment of a processing method for causing the above-described printer 3 to serve as a processing device will be explained. In the printing system shown in FIG. 1, when an e-mail with an attached file is transmitted from the communication terminal 1 to an e-mail address associated with the printer 3, it is desired to immediately execute printing of the attached file in the printer 3. Also, in terms of load on the server 2 and network traffic, it is not desired to conduct polling in the server 2 by using a message based on HTTP in order for the printer 3 to immediately acquire a print request. Thus, the printer 3 acquires a print request based on XMPP from the server 2. Since XMPP is a so-called push-type protocol that can transmit messages bi-directionally, the printer 3 does not need polling of the server 2. However, when the always-on connection based on XMPP is disconnected, there is a delay from the transmission of the e-mail from the communication terminal 1 to the e-mail address associated with the printer 3 until execution of printing by the printer 3. In the present embodiment, therefore, the always-on connection based on XMPP is maintained by a procedure shown in FIG. 2. The processing shown in FIG. 2 is conducted mainly by the CPU 31 that operates the connection control module 332, but, needless to say, the connection control module 332 and the OS 331 cooperate with each other in various situations.

First, the CPU 31 acquires connection control information β (for example, 30 seconds) and γ (for example, 3000 times) from the server 2 (S101). In this instance, since an always-on connection based on XMPP is not established between the server 2 and the printer 3, connection control information is acquired from the server 2 based on HTTP.

Next, the CPU 31 attempts an always-on connection with the server 2 based on XMPP (S102). Specifically, an account ID, a password, and the like assigned to the printer 3 are transmitted to the server 2 in accordance with XMPP together with a connection request. An always-on connection based on XMPP is referred to as an XMPP connection.

Next, the CPU 31 determines whether the XMPP connection succeeded or not (S103). In a case where the XMPP connection succeeded, the CPU 31 conducts processing of step S104 described next. In a case where the XMPP connection failed, the CPU 31 conducts processing of step S113 described later.

In step S104, the CPU 31 waits until communication based on XMPP occurs, or 290 seconds elapse without the occurrence of communication based on XMPP.

Next, the CPU 31 determines whether communication based on XMPP occurred, or 290 seconds elapsed without the occurrence of communication based on XMPP (S105). In a case where communication based on XMPP occurred, the CPU 31 conducts processing corresponding to the content of the communication, and the CPU 31 conducts a series of processing from step S104 again. In a case where 290 seconds elapsed without the occurrence of communication based on XMPP, the CPU 31 conducts processing of step S106 described next. Here, processing corresponding to the content of the communication refers to processing that acquires print data from the server 2 in a case of communication informing that print data exists in the server 2, and refers to processing that advises the server 2 of status information of the printer 3 in a case of communication requiring status information of the printer 3.

In step S106, the CPU 31 sends out a “Keep Alive” packet based on XMPP to the Internet via a LAN. Specifically, the CPU 31 sends out a “Keep Alive” packet based on XMPP to the Internet via a LAN every time 290 seconds elapse without the occurrence of communication based on XMPP. The reason why a “Keep Alive” packet is sent out in this manner is to prevent the XMPP connection from being disconnected by a router, a firewall, or a proxy server due to breakdown in message exchange based on XMPP for a certain period of time. The reason why a “Keep Alive” packet is sent out at the interval of 290 seconds is to be adapted to a broadband router that disconnects the XMPP connection after a non-communication state lasts for 300 seconds. In other words, an optimum value of the interval for sending a “Keep Alive” packet can be set corresponding to the communication environment, and the interval can be shorter or longer than 290 seconds.

After sending a “Keep Alive” packet, the CPU 31 waits until a response to the “Keep Alive” packet is received, or 75 seconds elapse without receiving a response to the “Keep Alive” packet (S108).

Next, the CPU 31 determines whether a response to the “Keep Alive” packet was received, or 75 seconds elapsed without receiving a response to the “Keep Alive” packet (S109). In a case where a response to the “Keep Alive” packet was received, the CPU 31 conducts a series of processing from step S104 again.

In a case where 75 seconds elapsed without receiving a response to the “Keep Alive” packet, it is determined whether waiting is conducted 9 times or the number of times of waiting is less than 9 (S110). In a case where waiting is not conducted 9 times before 75 seconds elapse without receiving a response to the “Keep Alive” packet, a series of processing from step S106 is conducted again.

In a case where waiting is conducted 9 times before 75 seconds elapse without receiving a response to the “Keep Alive” packet, the CPU 31 attempts a reconnection of the XMPP connection with the server 2 (S111). Specifically, an account ID, a password, and the like assigned to the printer 3 are transmitted to the server 2 based on XMPP together with a connection request. In this manner, the timing when a reconnection of the XMPP connection is attempted first since the XMPP connection is disconnected is approximately 675 seconds after the disconnection, and this timing corresponds to the second timing. The period of time from the disconnection to the second timing can be less than 675 seconds, or exceed 675 seconds. However, by attempting a reconnection of the XMPP connection after the elapse of a certain period of time from the disconnection, the XMPP connection can be restarted before the initial first timing occurs if the XMPP connection becomes possible in a short period of time from the disconnection. If connections with a number of printers 3 are disconnected at almost the same time due to a problem in the server 2 and the server 2 is restored before the second timing occurs, reconnection attempts concentrate in the server 2 from a number of printers 3 with respect to the second timing. However, a problem will not occur again due to load concentration in the server 2 with respect to the second timing by defining the rule that the server 2 will not be booted until a certain period of time elapses from the occurrence of the problem. Also, if the XMPP connection is disconnected due to a problem other than in the server 2 such as abnormality of a communication path of the printer 3, since the number of the printers 3 that conduct reconnection attempts is limited, reconnection attempts will not concentrate in the server 2.

Next, the CPU 31 determines whether the XMPP reconnection succeeded or not (S112). In a case where the XMPP reconnection failed, the CPU 31 conducts processing of step S113 described next. In a case where the XMPP reconnection succeeded, the CPU 31 conducts a series of processing from step S104 again.

In step S113, the CPU 31 acquires a uniform random number a (S113). The uniform random number α is a rational number that appears with an equal probability in a section from 0 to β. Specifically, the uniform random number α is a random number for randomly setting first timing per period of a length β. However, the uniform random number does not need to be a uniform random number in a strict sense as long as the timing of reconnection attempts described later is dispersed. For example, there can be variation within a tolerance level, or it can be limited to an integer.

Next, the CPU 31 waits until time of a length of the uniform random number a elapses (S114).

When time of a length of the uniform random number α elapses, the CPU 31 attempts a reconnection of the XMPP connection with the server 2 (S115). Consequently, a reconnection of the XMPP connection is attempted at the random first timing in each printer 3. Also, a single attempt of a reconnection of the XMPP connection is conducted per period of a length β in each printer 3. Opportunities of a reconnection of the XMPP connection are thus equalized in the plurality of printers 3 to be always-connected with the server 2 while dispersing the load on the server 2. [y1]

Next, the CPU 31 determines whether the XMPP reconnection succeeded or not (S116). In a case where the XMPP reconnection failed, the CPU 31 conducts processing of step S117 described next. In a case where the XMPP reconnection succeeded, the CPU 31 conducts a series of processing from step S104 again.

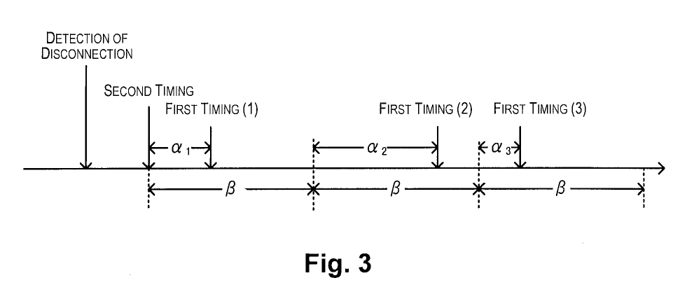

In a case where the XMPP reconnection failed, the CPU 31 waits until the time of β elapses from the start of waiting of step S114 (S117). Specifically, the CPU 31 waits until the elapse of time of a length obtained by subtracting time it takes for step S115 and step S116 from (β−α). In this manner, as shown in FIG. 3, the first timing to attempt a reconnection of the XMPP connection with the server 2 is set randomly once every period of a length β. Since α is a uniform random number, the expected value of the interval of the attempts of the XMPP reconnection is β acquired from the server 2. The average interval of the attempts of the XMPP reconnection by a number of printers 3 can thus be controlled to be an optimum interval by setting an appropriate expected value β in the server 2 in advance. As the number of the printers 3 connected with the server 2 by XMPP increases, the number of the printers 3 that attempt the XMPP reconnection with the server 2 after the XMPP connection with the server 2 is concurrently disconnected increases. It is thus preferable that the load concentration on the server 2 at the time of a reconnection is controlled by setting β to be greater as the number of the printers 3 that attempt the XMPP reconnection with the server 2 increases, and time required for a successful XMPP reconnection is shortened by setting β to be smaller as the number of the printers 3 that attempt the XMPP reconnection with the server 2 decreases. Specifically, the number of the printers 3 connected by XMPP in the server 2 is always monitored, and through the XMPP connection, the server 2 periodically informs the printer 3 of β and γ based on the number of the printers 3 connected by XMPP at the time. The printer 3 sets the informed β and γ such that they are used for a subsequent reconnection. In a case where the server 2 knows in advance that the XMPP connection will be disconnected due to maintenance and the like, it is preferable that the expected value β and γ are informed based on the number of the printers 3 immediately before the XMPP connection is disconnected. Also, the expected value β can be set based on the actually registered number of the printers 3 that can be connected with the server 2 by XMPP (the registration number of XMPP accounts in the server 2) or the shipment number of the printers 3 that can be connected with the server 2 by XMPP, and stored in the printer 3 in advance.

Next, the CPU 31 determines whether reconnection attempts at the first timing are conducted γ times or the number of times of reconnection attempts at the first timing is less than γ (S118).

In a case where the number of times of reconnection attempts at the first timing is less than γ, the CPU 31 conducts a series of processing from step S113 again. Consequently, the XMPP reconnection is attempted γ times at a maximum at the first timing that is randomly set each time.

When the number of times of reconnection attempts at the first timing reaches γ, the XMPP reconnection processing described heretofore ends. Unless a reconnection of the XMPP connection between the server 2 and the printer 3 succeeds before (γ×β) elapses from the second timing to attempt the XMPP reconnection immediately after detection of the disconnection, the reconnection of the XMPP connection by the printer 3 after the disconnection of the XMPP connection ends. Accordingly, the threshold value γ can be determined depending on a maximum amount of time required for restoration assumed in the server 2, and β, for example.

### 3. Second Embodiment of Processing Method

Next, a second embodiment of a processing method for causing the printer 3 to serve as a processing device will be explained. In the second embodiment, the interval itself of the first timing to attempt the XMPP reconnection is randomly set, and the expected value of the interval of the first timing is set to be β that is set in advance. Since processing from step S101 to step S112 is the same as the first embodiment, explanations will be omitted, and processing after step S112 will be explained in detail hereinafter.

When the reconnection attempt immediately after the disconnection of the XMPP connection fails in step S112, the CPU 31 acquires a uniform random number ω (S123). The uniform random number ω is a rational number that appears with an equal probability in a section from 0 to 2β. Specifically, the uniform random number ω is a random number in which the average value is β. However, the uniform random number does not need to be a uniform random number in a strict sense as long as the timing of reconnection attempts described later is dispersed. For example, there can be variation within a tolerance level, or it can be limited to an integer.

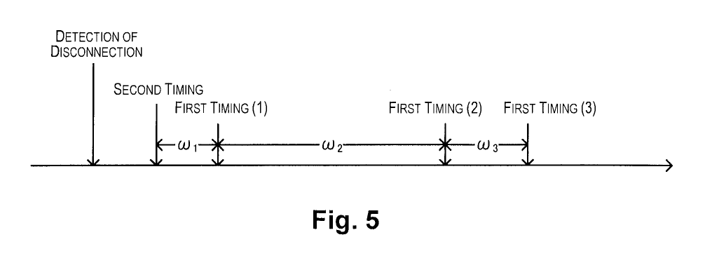

Next, the CPU 31 waits until time of a length of the uniform random number ω elapses (S124). When time of a length of the uniform random number ω elapses, the CPU 31 attempts a reconnection of the XMPP connection with the server 2 (S125). Consequently, as shown in FIG. 5, a reconnection of the XMPP connection is attempted at the first timing having the random interval ω therebetween. In the present embodiment, the interval itself of the first timing is randomly set. Accordingly, although the number of times of reattempts does not coincide in each printer 3 per certain interval, since the first timing is set such that the expected value of the interval of the first timing is β, attempt opportunities are equalized in the plurality of printers 3 by repeating a XMPP reconnection attempt in each printer 3.

Next, the CPU 31 determines whether the XMPP reconnection succeeded or not (S126). In a case where the XMPP reconnection failed, the CPU 31 conducts processing of step S128 described next. In a case where the XMPP reconnection succeeded, the CPU 31 conducts a series of processing from step S104 again.

Next, the CPU 31 determines whether XMPP reconnection attempts at the first timing are conducted γ times or the number of times of XMPP reconnection attempts at the first timing is less than γ (S128).

In a case where the number of times of XMPP reconnection attempts at the first timing is less than γ, the CPU 31 conducts a series of processing from step S123 again.

When the number of times of XMPP reconnection attempts at the first timing reaches γ, the XMPP reconnection processing described heretofore ends. Since the expected value of the interval of the first timing is β, unless a reconnection of the XMPP connection between the server 2 and the printer 3 succeeds before (γ×β) elapses from the second timing to attempt the XMPP reconnection immediately after detection of the disconnection, the reconnection of the XMPP connection by the printer 3 after the disconnection of the XMPP connection ends. Accordingly, the threshold value γ can be determined depending on a maximum amount of time required for restoration assumed in the server 2, for example, in the same manner as the first embodiment.

### 4. Another Embodiment

The technical scope of the invention is not limited to the above-described embodiments. Various modifications such as combination of one or more modification examples described below can be possible without substantially departing from the subject matter of the invention.

For example, the uniform random number α and the uniform random number ω for repetition of γ times do not need to be acquired every time a reconnection is attempted, and it can be possible to acquire all together in advance.

The unit of β, α, or ω can be arbitrarily determined without departing from the subject matter of the invention. For example, seconds can be possible, 0.1 seconds can be possible, or clock cycles can be possible.

The server 2 can be constructed of a plurality of physically independent computers, or can be constructed of a single computer.

Regarding the communication protocol for an always-on connection between the printer 3 and the server 2, a communication protocol other than XMPP can be used. For example, transmission can be conducted by using a push-type communication protocol (protocol that does not need a request from a client to conduct processing from the server to the client) other than XMPP such as SIP (Session Initiation Protocol) or SIMPLE (SIP for Instant Messaging and Presence Leveraging Extensions).

Needless to say, the invention can be applied to various information devices other than a printer as the processing terminal.

What is claimed is:

1. A processing terminal comprising:
a communication unit that establishes a connection with a server and conducts communication;
a processing unit that executes predetermined processing based on information acquired from the server through the communication;
a disconnection detecting unit that detects a disconnection of the connection; and
a reconnecting unit that attempts a reconnection with the server at first timing that occurs with random timing within a period of time that repeats and has a predetermined length in a case where a disconnection of the connection is detected.

2. A processing terminal comprising:
a communication unit that establishes a connection with a server and conducts communication;
a processing unit that executes predetermined processing based on information acquired from the server through the communication;
a disconnection detecting unit that detects a disconnection of the connection; and
a reconnecting unit that attempts a reconnection with the server at first timing that occurs at an interval of random lengths that do not exceed an upper limit having a predetermined length.

3. The processing terminal according to claim 1, wherein the reconnecting unit attempts a reconnection with the server at predetermined second timing before the initial first timing occurs after a disconnection of the connection is detected.

4. The processing terminal according to claim 2, wherein the reconnecting unit attempts a reconnection with the server at predetermined second timing before the initial first timing occurs after a disconnection of the connection is detected.

5. The processing terminal according to claim 1, wherein the reconnecting unit sets the predetermined length based on connection control information acquired from the server.

6. The processing terminal according to claim 2, wherein the reconnecting unit sets the predetermined length based on connection control information acquired from the server.

7. A processing method comprising:
establishing a connection with a server and conducting communication;
executing predetermined processing based on information acquired from the server through the communication;
detecting a disconnection of the connection; and
attempting a reconnection with the server at first timing that occurs with random timing within a period of time that repeats and has a predetermined length, or at first timing that occurs at an interval of random lengths that do not exceed an upper limit having a predetermined length, in a case where a disconnection of the connection is detected.
